(19) United States
(12) Patent Application Publication
(10) Pub. No.: US 2003/0190913 A1
(43) Pub. Date: Oct. 9, 2003

(54) Subscriber registration method

(76) Inventors: Alan Coad, Dublin (IE); Fergal O' Sullivan, Dublin (IE); Nelson Kobayshi, Sao Paulo (BR)

Correspondence Address: JACOBSON HOLMAN PLLC, 400 SEVENTH STREET N.W., SUITE 600, WASHINGTON, DC, 20004, US

(21) Appl. No.: 10/359,712

(22) Filed: Feb. 7, 2003

Related U.S. Application Data
(63) Continuation of application No. PCT/IE01/00102, filed on Aug. 2, 2001.

(30) Foreign Application Priority Data
Aug. 8, 2000 (IE) 2000/0624

(51) Int. Cl. H04Q 7/20; H04K 3/00

(52) U.S. Cl. 455/435.1; 455/432.1

(57) ABSTRACT

A mobile user in a visited network, in which they would otherwise be denied service, is allowed make calls in a pre-paid account automatically set up by a visited network. An auxiliary HLR recognises that the user would normally be denied service and, on receipt of a registration request, sets up an account, which is made active in a final stage after notification to the user in a Short Message and payment of funds.

### FIELD OF THE INVENTION

The invention relates to registration of subscribers for roaming in a visited network.

### PRIOR ART DISCUSSION

At present, it is not possible for a subscriber to register in a visited network if the visited network does not have a roaming agreement with the subscriber's home network, or if the home network forbids registration to a particular subscriber.

One approach to addressing this problem, described in PCT Patent Specification No. WO99/46926 (Ericsson) involves use of an Intelligent Pre-paid Service Card. This allows the mobile phone itself to deduct the call cost and so a pre-paid phone can be used in a visited network while roaming. While this approach appears to be useful for roaming pre-paid users, it does not address the situation where the user does not have this functionality in her phone or in general is not a pre-paid user.

Therefore, the invention is directed towards allowing any user to use her phone in a visited network in which she would otherwise be denied service.

### SUMMARY OF THE INVENTION

According to the invention, there is provided a method of allowing a person to use a mobile phone in a visited network, in which she would normally be denied service, the method comprising the steps of:—

the visited network receiving a registration request from the user's mobile phone, and

the visited network recognising that the user cannot be registered with the home network and automatically setting up a local pre-paid account for the user.

In one embodiment, the visited network sets up the pre-paid account in two stages as follows:—

an initial stage in which an account is set up with an inactive status,

a final stage in which the account is activated after payment of funds by the user.

In another embodiment, the visited network applies a default profile to the account in the initial stage.

In a further embodiment, the visited network notifies the user of the account after completion of the initial stage.

In one embodiment, the notification is transmitted in a Short Message.

In another embodiment, the visited network automatically cancels the account if the final stage is not completed after a pre-set time or upon failure to deliver the notification.

In a further embodiment, the method comprises the further steps of the visited network making a registration request to a home network of the user, and for proceeding with account set-up if the home network denies registration.

In one embodiment, the registration method is directed by an auxiliary HLR in the visited network.

In another embodiment, the account is set-up in an account system for local pre-paid subscribers.

In one embodiment, a pre-paid platform of the visited network manages the account.

In another embodiment, the visited network cancels the account automatically after a configurable duration of inactivity.

According to another aspect, the invention provides a mobile network HLR comprising means for controlling a method as defined above.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a flow diagram illustrating a registration method of the invention;

FIG. 2 is a diagram illustrating signalling for a situation for which there is no roaming agreement; and

FIG. 3 is a flow diagram illustrating signalling for a situation in which there is a roaming agreement but a subscriber does not have roaming rights.

### DESCRIPTION OF THE EMBODIMENTS

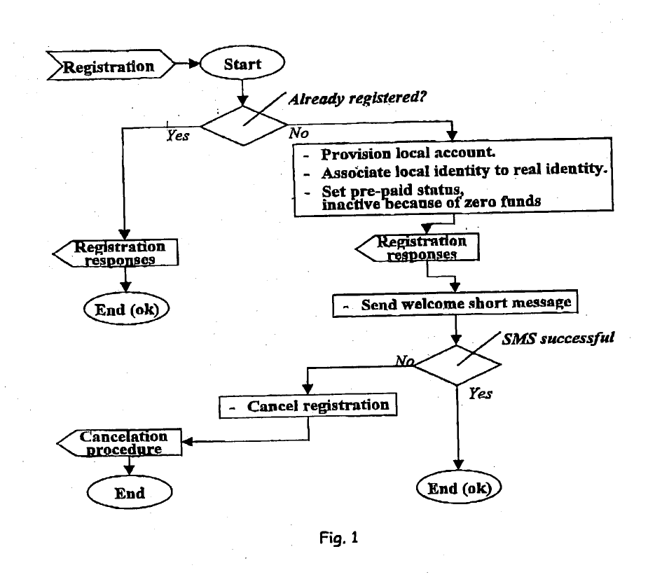

Referring to FIG. 1, the invention provides a registration method comprising the following steps, at a high level.

1. A subscriber of a home network roams in a visited network which does not have a roaming agreement with the home network. The subscriber turns on her handset, which attempts to register with an MSC/VLR.

2. As there is no roaming agreement, the registration message (e.g. REGNOT in ANSI 41, or Location-Update in GSM) from the MSC/VLR is routed to an auxiliary HLR in the visited network. The auxiliary HLR function is provided as a conventional existing HLR.

3. The auxiliary HLR assigns a local identity for the visiting subscriber using a default profile, as a pre-paid subscriber. This identity may be previously provisioned in a pre paid platform or could be created on the fly by an interaction between the auxiliary HLR and the pre-paid platform.

4. The auxiliary HLR sends the appropriate responses to the MSC/VLR, indicating that the subscriber is registered as a local pre-paid subscriber, albeit without the ability to make calls or send short messages because funds have not yet been paid.

5. The auxiliary HLR sends a short message to the subscriber informing her that she is registered as a local pre-paid subscriber and that she needs to buy a pre-paid card to make or receive calls. This short message may be sent in one of two ways (in either case failure to deliver the message will result in the registration being rescinded):

Via a short message service centre (message center) using SMPP or equivalent. In this case the message is sent using the local identity.

Directly by the auxiliary HLR using MAP signalling. This is less reliable as there may be temporary problems in delivering the message.

6. The subscriber recharges the pre-paid account and becomes a new active subscriber in the visited network using her own “home” handset.

This process is set out in FIG. 1. This diagram also demonstrates that the preliminary registration is rescinded (deleted from the platform database) if transmission of the short message fails.

Various policies may be implemented to delete entries that have not been activated or have been idle for a long time.

The auxiliary HLR can delete entries after a configurable period of inactivity.

The pre-paid platform can delete entries after a configurable period of inactivity

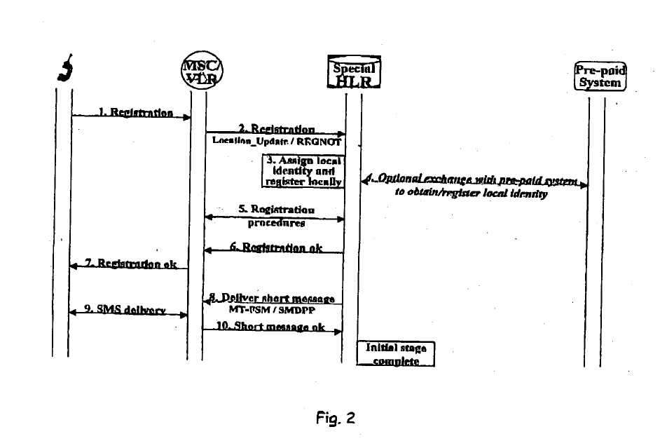

FIG. 2 shows MAP signalling for the case where there is no roaming agreement, as described below.

1. Mobile attempts to register with a serving MSC/VLR

2. The serving MSC/VLR in the visited network sends a registration request towards an HLR (in GSM, this is a “Location-Update”; in ANSI 41 this is a REGNOT). As there is no roaming agreement, this request is sent to the auxiliary HLR in the visited network.

3. The auxiliary HLR assigns a local identity for the visiting subscriber using a default profile, as a pre-paid subscriber. This number may be previously provisioned in the pre paid platform, or

4. Optional interaction between the auxiliary HLR and the pre-paid platform for on-the-fly retrieval of previously provisioned identity.

5. Exchange of MAP messages to register the subscriber and provide profile details, including the local identity to the MSC/VLR.

6. Successful registration is indicated to the serving MSC/VLR

7. The serving MSC/VLR completes the registration transaction with the mobile.

8. The auxiliary HLR, acting as a pseudo short message service centre (message center), sends a welcome short message to the visiting subscriber. The required routing information is already known to the auxiliary HLR.

9. The serving MSC delivers the short message,

10. The servicing MSC sends status to the auxiliary HLR. As this is successful, the initial registration stage is complete.

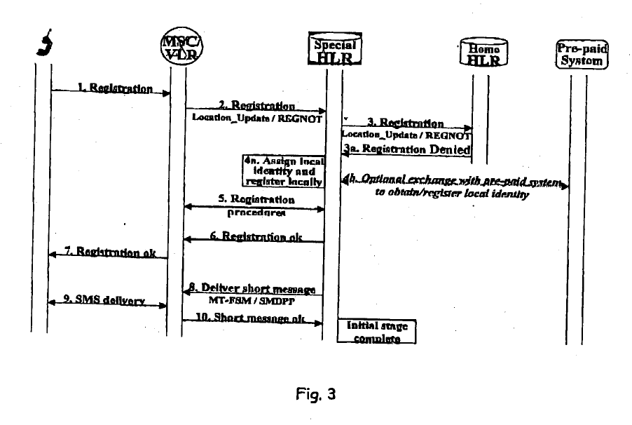

FIG. 3 shows the scenario for the case where there is a roaming agreement but the subscriber does not have roaming rights.

1. Mobile attempts to register with a serving MSC/VLR

2. The serving MSC/VLR in the visited network sends a registration request towards an HLR. This is routed through a signalling relay function, which may be a separate network element or embedded function deployed on the auxiliary HLR platform. The diagram shows it embedded in the auxiliary HLR

3. The signalling relay function relays the registration to the Home HLR.

3a. The response indicates that registration is not possible.

4. Registration is handled by the HLR in the visited network

5. to 10. Interaction proceeds as illustrated in FIG. 1.

The following are aspects of implementation of the invention.

This service is implemented in a generic HLR platform, having added functionality for performing the above subscriber provisioning. However, the auxiliary HLR would be provided as a separate entity.

In addition to its basic functionality the auxiliary HLR platform is also capable of relaying a query to another HLR (in the home network) and inspecting the response. If the response is positive, the platform can act as a relay pipe. If it is unsuccessful, a local entry is provisioned automatically.

The subscriber is provisioned into the auxiliary HLR using a default profile (configurable by the operator) that corresponds to a profile of a local pre-paid subscriber. For example it might include an Origination-Request-Indicator (ANSI 41) or an appropriate Camel Service Indicator (GSM).

After the successful provisioning, the auxiliary HLR sends the appropriate responses containing the profile of the subscriber.

Then it sends a Short Message (either via an SMSC or directly using a MAP message) to inform the subscriber of her new local number and how she should buy a pre-paid card or make payment in another manner.

After the registration has been completely idle for a configurable period (configurable by operator) it can be cancelled automatically.

Such default registration should only be permitted in cases where it is known that there is no other operator in the visited country through which the subscriber would be permitted by the home network to register.

The invention is not limited to the embodiments described but may be varied in construction and detail.

1. A method of allowing a person to use a mobile phone in a visited network, in which she would normally be denied service, the method comprising the steps of:—
the visited network receiving a registration request from the user's mobile phone, and
the visited network recognising that the user cannot be registered with the home network and automatically setting up a local pre-paid account for the user.

2. A method as claimed in claim 1, wherein the visited network sets up the pre-paid account in two stages as follows:—
an initial stage in which an account is set up with an inactive status,
a final stage in which the account is activated after payment of funds by the user.

3. A method as claimed in claim 2, wherein the visited network applies a default profile to the account in the initial stage.

4. A method as claimed in claim 2, wherein the visited network notifies the user of the account after completion of the initial stage.

5. A method as claimed in claim 2, wherein the visited network notifies the user of the account after completion of the initial stage; and wherein the notification is transmitted in a Short Message.

6. A method as claimed in claim 1, wherein the visited network notifies the user of the account after completion of the initial stage; and wherein the visited network automatically cancels the account if the final stage is not completed after a pre-set time or upon failure to deliver the notification.

7. A method as claimed in claim 1, wherein the method comprises the further steps of the visited network making a registration request to a home network of the user, and for proceeding with account set-up if the home network denies registration.

8. A method as claimed in claim 1, wherein the registration method is directed by an auxiliary HLR in the visited network.

9. A method as claimed in claim 1, wherein the account is set-up in an account system for local pre-paid subscribers.

10. A method as claimed in claim 9, wherein a pre-paid platform of the visited network manages the account.

11. A method as claimed in claim 1, wherein the visited network cancels the account automatically after a configurable duration of inactivity.

12. A mobile network HLR comprising means for controlling a method as claimed in claim 1.
